(19) United States
(12) Patent Application Publication
(10) Pub. No.: US 2019/0184578 A1
(43) Pub. Date: Jun. 20, 2019

(54) Grasping Hand And Robot

(71) Applicant: Seiko Epson Corporation, Tokyo (JP)

(72) Inventors: Tomo IKEBE, Suwa (JP); Osamu MIYAZAWA, Shimosuwa (JP)

(21) Appl. No.: 16/222,013

(22) Filed: Dec. 17, 2018

(30) Foreign Application Priority Data
Dec. 18, 2017 (JP) 2017-241646

(51) Int. Cl. B25J 13/08; B25J 9/16

(52) U.S. Cl. CPC B25J 13/082; B25J 15/026; B25J 9/1612

(57) ABSTRACT

A grasping hand includes a grasping section, a motor configured to generate a driving force for moving the grasping section, and a transmitting mechanism including a first member and a second member configured to transmit the driving force to the grasping section. The first member is supported by a shaft member and moves along the shaft member to move the second member. The second member moves in a direction parallel to the shaft member to move the grasping section. A pressure sensor is provided between the first member and the second member.

### BACKGROUND

### 1. Technical Field

The present invention relates to a grasping hand and a robot.

### 2. Related Art

A robot such as a vertical articulated robot or a horizontal articulated robot includes a robot arm. In general, an end effector such as a hand is mounted on the distal end of the robot arm. As a type of such an end effector, a grasping hand capable of grasping an object is known.

For example, an electric hand described in JP-A-2014-24134 (Patent Literature 1) includes an electric motor, a rotational-linear motion converting mechanism configured to convert a rotational motion of the electric motor into a linear motion, a pair of finger bases configured to linearly move via the rotational-linear motion converting mechanism, a pair of fingers fixed to the pair of finger bases, and a force sensor configured to detect a force (a grasping force) in an opening and closing direction of the fingers. The force sensor includes a pair of electrodes having a gap that changes according to an external force applied to the finger bases. The force sensor detects capacitance between the pair of electrodes to detect a grasping force.

However, in the electric hand described in Patent Literature 1, the gap between the pair of electrodes has to be changed according to the external force applied to the finger bases. Therefore, the influence of a moment depending on a grasping position of the finger bases is large. The grasping force cannot be directly detected.

### SUMMARY

An advantage of some aspects of the invention is to provide a grasping hand that can highly accurately detect a force applied to a grasping section and provide a robot including the grasping hand.

The invention can be implemented as the following application examples or forms.

A grasping hand according to an application example of the invention includes: a grasping section; a motor configured to generate a driving force for moving the grasping section; and a transmitting mechanism including a first member and a second member configured to transmit the driving force to the grasping section. The first member is supported by a shaft member and moves along the shaft member to move the second member. The second member moves in a direction parallel to the shaft member to move the grasping section. A pressure sensor is provided between the first member and the second member.

With such a grasping hand, since the pressure sensor is provided between the first member and the second member of the transmitting mechanism configured to transmit the driving force generated by the motor to the grasping section, a force (a grasping force, a pressing force, etc.) applied to the grasping section can be directly detected by the pressure sensor. The force applied to the grasping section can be highly accurately detected by the pressure sensor because the rigidity of the pressure sensor is high. A reduction in the size and a reduction in the weight of the transmitting mechanism and a reduction in the size and a reduction in the weight of the grasping hand can be achieved because the pressure sensor is thin.

In the grasping hand according to the application example, it is preferable that the transmitting mechanism converts rotation of the motor into an opening and closing motion of a pair of the grasping sections.

With this configuration, the pair of grasping sections can be opened and closed by a relatively simple and inexpensive configuration. The mechanism that performs such conversion less easily transmits the force applied to the grasping section to the motor. Therefore, the grasping section can be prevented from being displaced by the force.

In the grasping hand according to the application example, it is preferable that the grasping hand includes: a case; and a guide member supported by the case and configured to guide the second member.

With this configuration, the second member can be stably moved in a desired direction.

In the grasping hand according to the application example, it is preferable that the first member and the second member are coupled by a screw.

With this configuration, it is possible to change an output of the pressure sensor according to the force applied to the grasping section while coupling the first member and the second member with relatively high rigidity.

In the grasping hand according to the application example, it is preferable that the pressure sensor includes: a first pressure sensor disposed on the grasping section side with respect to the screw; and a second pressure sensor disposed on an opposite side of the grasping section with respect to the screw.

With this configuration, a force applied to the grasping section when the pair of grasping sections approaches each other can be detected by one sensor of the first pressure sensor and the second pressure sensor. A force applied to the grasping section when the pair of grasping sections separates from each other can be detected by the other sensor.

In the grasping hand according to the application example, it is preferable that the first pressure sensor and the second pressure sensor are disposed on a same board.

With this configuration, wire laying of the pressure sensor can be simplified. Alignment of the first pressure sensor and the second pressure sensor can also be simplified.

In the grasping hand according to the application example, it is preferable that the pressure sensor is a pressure sensor of a resistance type including resin and a conductive material.

With this configuration, a reduction in the thickness and an increase in the rigidity of the pressure sensor can be achieved.

In the grasping hand according to the application example, it is preferable that the conductive material is a carbon nanotube.

With this configuration, the durability, the load resistance, and the rigidity of the pressure sensor can be improved.

A robot according to an application example of the invention includes the grasping hand according to the application example explained above.

With such a robot, characteristics of the robot can be improved using the effects of the grasping hand.

### BRIEF DESCRIPTION OF THE DRAWINGS

The invention will be described with reference to the accompanying drawings, wherein like numbers reference like elements.

FIG. 1 is a sectional view of a grasping hand according to a first embodiment of the invention.

FIG. 2 is an enlarged sectional view showing a first member, a second member, and a pressure sensor included in the grasping hand shown in FIG. 1.

FIG. 3 is a plan view of the first member and the second member shown in FIG. 2 viewed from an overlapping direction of the first member and the second member.

FIG. 4 is a plan view of the pressure sensor shown in FIG. 2.

FIG. 5 is an enlarged sectional view of a pressure sensitive section of the pressure sensor shown in FIG. 2.

FIG. 6 is a plan view showing a modification of the pressure sensor.

FIG. 7 is an enlarged sectional view showing a first member, a second member, and a pressure sensor included in a grasping hand according to a second embodiment of the invention.

FIG. 8 is a plan view of the first member and the second member shown in FIG. 7 viewed from an overlapping direction of the first member and the second member.

FIG. 9 is a perspective view showing a robot according to an embodiment of the invention.

### DESCRIPTION OF EXEMPLARY EMBODIMENTS

Preferred embodiments of the invention are explained in detail below with reference to the drawings.

### 1. Grasping Hand

### First Embodiment

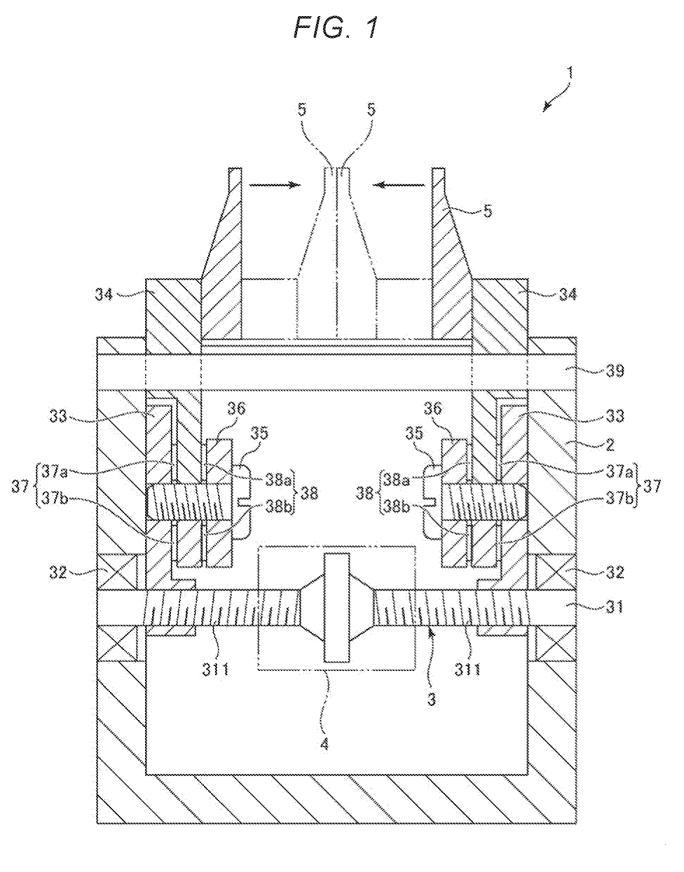

FIG. 1 is a sectional view of a grasping hand according to a first embodiment of the invention. In the following explanation, for convenience of explanation, the upper side in FIG. 1 is referred to as “upper” and the lower side in FIG. 1 is referred to as “lower”.

A grasping hand 1 shown in FIG. 1 is attached to, for example, an arm distal end portion of an industrial robot and used to grasp an object. The grasping hand 1 includes a case 2, a transmitting mechanism 3 and a motor 4 set in the case 2, and a pair of grasping sections 5 attached to the transmitting mechanism 3.

The transmitting mechanism 3 opens and closes the pair of grasping sections 5 with a driving force generated by the motor 4. Pressure sensors 37 configured to detect a force applied to the grasping sections 5 are provided in the transmitting mechanism 3. Consequently, it is possible to grasp the object with an appropriate grasping force with the pair of grasping sections 5 by performing driving control of the motor 4 on the basis of a result of the detection of the pressure sensors 37. In particular, the force applied to the grasping sections 5 can be highly accurately detected by the pressure sensors 37. Since the pressure sensors 37 are small and thin, a reduction in the size and a reduction in the weight of the transmitting mechanism 3 and a reduction in the size and a reduction in the weight of the grasping hand 1 can be achieved. First, the sections of the grasping hand 1 are briefly explained below.

The case 2 has a box shape opened upward. The case 2 has a function of supporting the transmitting mechanism 3 and the motor 4 and protecting the transmitting mechanism 3 and the motor 4 from the outside. A constituent material of the case 2 is not particularly limited. Examples of the constituent material include metal materials such as aluminum, stainless steel, and iron. In such a case 2, the transmitting mechanism 3 and the motor 4 are set. A part of the transmitting mechanism 3 is exposed from the opening of the case 2. The grasping sections 5 are attached to the part. The shape of the case 2 is not limited to the shape shown in FIG. 1 as long as the case 2 can exert the function explained above.

Although not shown in detail, the motor 4 is a rotary motor capable of normally and reversely rotating. The motor 4 is not particularly limited. For example, a DC motor, an AC motor, a stepping motor, a reluctance motor, an ultrasonic motor (a piezoelectric motor), and the like can be used. The motor 4 is electrically connected to a not-shown motor driver and driven by a driving current received from the motor driver. Although not shown in FIG. 1, the grasping hand 1 includes an encoder configured to detect a rotation angle of the motor 4 or a feed screw 31 explained below. An output signal of the encoder is input to the motor driver and used for driving control of the motor 4. A setting position of the motor 4 may be any position as long as the motor 4 can input the driving force to the transmitting mechanism 3. The setting position of the motor 4 is not limited to the position shown in FIG. 1 and may be, for example, the outside of the case 2.

The transmitting mechanism 3 has a function of transmitting the driving force of the motor 4 to the pair of grasping sections 5. In this embodiment, the transmitting mechanism 3 has a function of converting a rotational motion of the motor 4 into a linear motion. Consequently, the pair of grasping sections 5 can be opened and closed by the driving force of the rotary motor 4.

Specifically, the transmitting mechanism 3 includes a feed screw 31, a pair of bearings 32 configured to rotatably support the feed screw 31 with respect to the case 2, a pair of first members 33 having portions that mesh with the feed screw 31, a pair of second members 34 coupled to the pair of first members 33 using screws 35 and washers 36, and a guide 39 configured to movably support the pair of second members 34. Constituent materials of these sections are not particularly limited. Examples of the constituent materials include metal materials such as aluminum, stainless steel, and iron.

The feed screw 31 is disposed to extend in the left-right direction in FIG. 1. The feed screw 31 includes a pair of screw sections 311 provided on the left and the right. One of the pair of screw sections 311 is a forward screw (a right screw) and the other is a backward screw (a left screw). Both end portions of such a feed screw 31 are rotatably supported by the case 2 via the pair of bearings 32. The bearings 32 are, for example, ball bearings.

Such a feed screw 31 rotates with the driving force of the motor 4. Although not shown in FIG. 1, a gear is provided in the feed screw 31. A gear provided in a rotating shaft of the motor 4 meshes with this gear. Consequently, the feed screw 31 can be normally or reversely rotated by the motor 4. A configuration for transmitting the driving force from the motor 4 to the feed screw 31 is not limited to a configuration in which the gear is used. The configuration may be, for example, a configuration in which a belt and a pulley are used or may be a configuration in which the rotating shaft of the motor 4 is directly connected to the feed screw 31. When the motor 4 is a piezoelectric motor, the feed screw 31 may be configured integrally with a rotating shaft of the piezoelectric motor.

The pair of first members 33 is respectively disposed to extend from the feed screw 31 side to the opening side of the case 2. A lower part of one first member 33 is screwed with one screw section 311 (on the left side in FIG. 1) of the feed screw 31. A lower part of the other first member 33 is screwed with the other screw section 311 (on the right side in FIG. 1) of the feed screw 31. Therefore, by rotating the feed screw 31, the pair of first members 33 moves (linearly moves) to approach or separate. The first members 33 are not limited to a configuration in which the first members 33 are directly screwed with the feed screw 31. For example, the first members 33 may be attached to another member screwed with the feed screw 31.

The pair of second members 34 is respectively disposed to extend from the feed screw 31 side to the opening side of the case 2 such that parts of the pair of second members 34 project to the outside from the opening formed in the upper part of the case 2. One second member 34 (on the left side in FIG. 1) is coupled to the one first member 33 using the screw 35 and the washer 36. The other second member 34 (on the right side in FIG. 1) is coupled to the other first member 33 using the screw 35 and the washer 36.

The pair of second members 34 is respectively movably supported by the guide 39 to approach or separate from each other in the left-right direction in FIG. 1 along the guide 39. The guide 39 is configured by a bar-like member. The guide 39 is disposed to extend in the left-right direction in FIG. 1 and supported by the case 2. The configuration of the guide 39 is not limited to the configuration shown in FIG. 1 as long as the guide 39 is capable of moving the pair of second members 34 to approach or separate from each other. For example, the guide 39 may be configured by a plurality of bar-like members disposed in parallel to one another. In this case, the guide 39 that supports one second member 34 and the guide 39 that supports the other second member 34 may be configured by separate members.

The pressure sensors 37 are disposed between the first members 33 and the second members 34 of the transmitting mechanism 3 configured as explained above. The pressure sensors 37 detect a force applied to the grasping sections 5. Pressure sensors 38 are disposed between the second members 34 and the washers 36. The pressure sensors 38 also detect the force applied to the grasping sections 5. The pressure sensors 37 and 38 and configurations concerning the pressure sensors 37 and 38 are explained in detail below.

The grasping sections 5 are attached to the second members 34 of the transmitting mechanism 3 by a fixing method such as screwing. The pair of grasping sections 5 is portions that grasp an object. A constituent material of the grasping sections 5 is not particularly limited. Examples of the constituent material include metal materials such as aluminum, stainless steel, and iron and ceramic materials. The shape of the grasping sections 5 is determined according to, for example, a type of an object and is not limited to the shape shown in FIG. 1.

The sections of the grasping hand 1 are briefly explained above. In the grasping hand 1, the driving force generated by the motor 4 is transmitted to the pair of grasping sections 5 by the transmitting mechanism 3. The pair of grasping sections 5 moves in the lateral direction in FIG. 1 and opposite directions according to a rotating direction of the motor 4 and approaches or separates from each other. When a force is applied to the grasping sections 5, pressure applied to the pressure sensors 37 disposed between the first members 33 and the second members 34 of the transmitting mechanism 3 and pressure applied to the pressure sensors 38 disposed between the second members 34 and the washers 36 of the transmitting mechanism 3 change. Therefore, the force applied to the grasping sections 5 can be detected by the pressure sensors 37 and 38. The pressure sensors 37 and 38 and matters related to the pressure sensors 37 and 38 are explained in detail below.

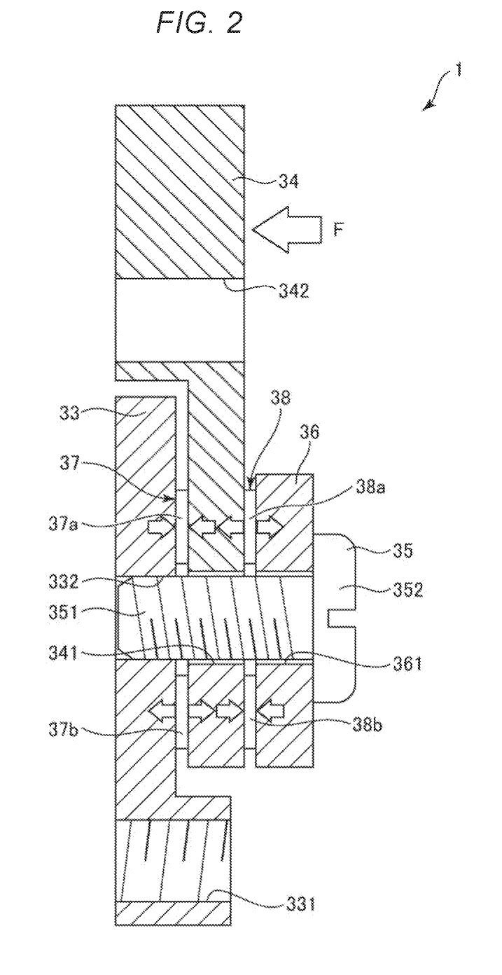

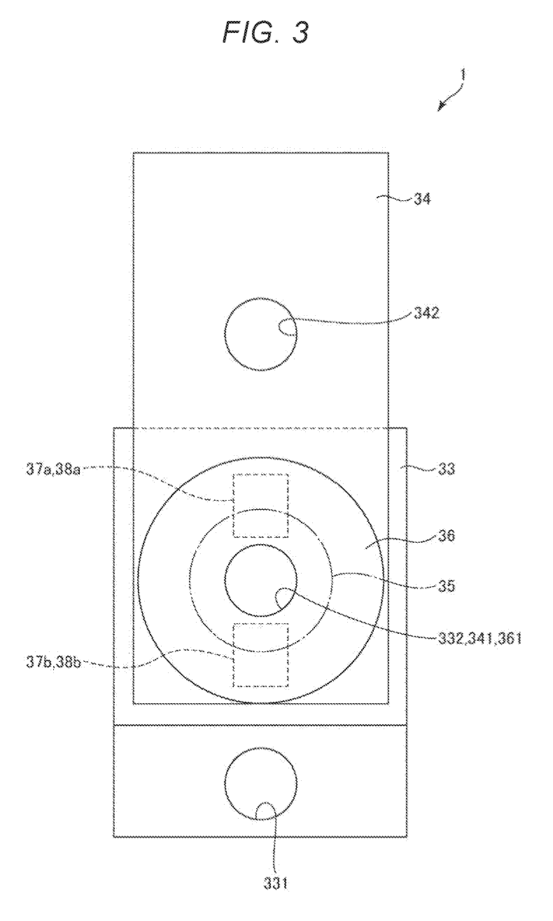

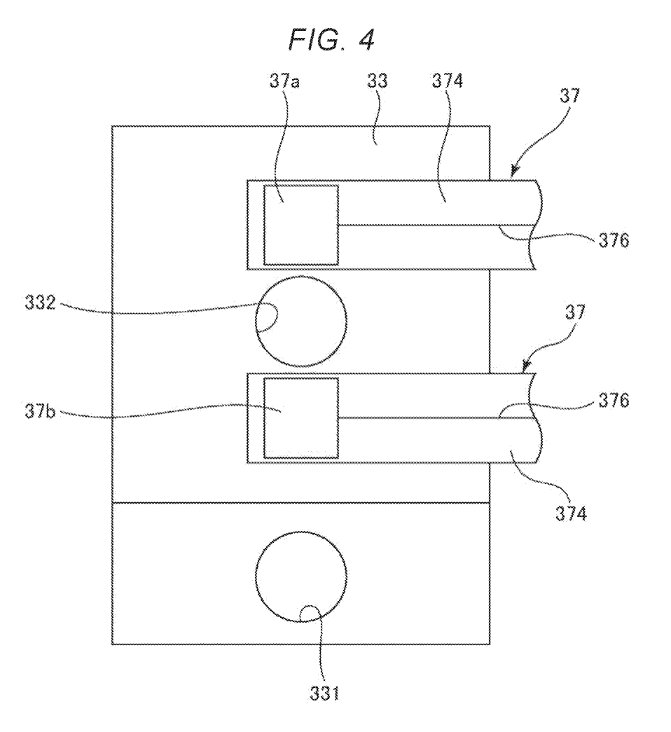

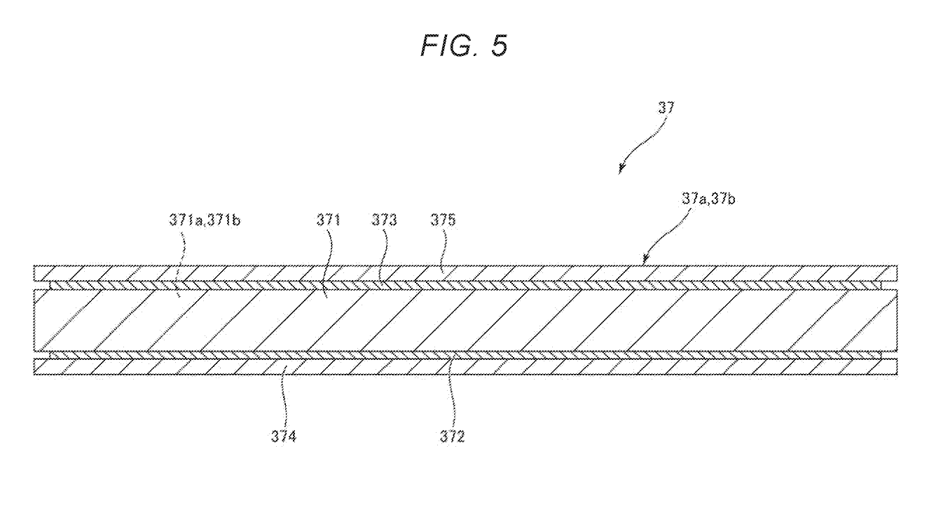

FIG. 2 is an enlarged sectional view of the first member, the second member, and the pressure sensor included in the grasping hand shown in FIG. 1. FIG. 3 is a plan view of the first member and the second member shown in FIG. 2 viewed from an overlapping direction of the first member and the second member. FIG. 4 is a plan view of the pressure sensor shown in FIG. 2. FIG. 5 is an enlarged sectional view of a pressure sensitive section of the pressure sensor shown in FIG. 2.

As shown in FIGS. 2 and 3, the first member 33 and the second member 34 are respectively formed in a substantially tabular shape. The first member 33 and the second member 34 are superimposed and disposed to face plate surfaces thereof to each other. The first member 33 includes a screw hole 331 in which the screw section 311 of the feed screw 31 is screwed and a screw hole 332 in which a screw section 351 of the screw 35 is screwed. The screw holes 331 and 332 respectively pierce through the first member 33 in the thickness direction of the first member 33. The second member 34 includes a through-hole 341 through which the screw section 351 (a shaft section) of the screw 35 is inserted and a through-hole 342 configuring a guide surface through which the guide 39 is inserted. The shapes of the first member 33 and the second member 34 are not limited to the shapes shown in FIGS. 2 and 3 as long as the pressure sensor 37 can be clamped between the first member 33 and the second member 34. However, contact surfaces with the pressure sensor 37 are desirably planes. The screw hole 331 may be a through-hole through which the screw section 311 of the feed screw 31 is inserted. In this case, the screw section 311 only has to be fastened to another member such as a nut on the opposite side of the second member 34 with respect to the first member 33.

The washer 36 including a through-hole 361 through which the screw section 351 of the screw 35 is inserted is disposed on the opposite side of the first member 33 with respect to the second member 34. The screw 35 is fastened to the first member 33 from the second member 34 side via the washer 36 such that a head 352 of the screw 35 is present on the second member 34 side. Consequently, the first member 33 and the second member 34 are coupled using the screw 35 and the washer 36. The shape of the washer 36 is not limited to the shape shown in FIGS. 2 and 3 as long as the pressure sensor 38 can be clamped between the second member 34 and the washer 36. However, a contact surface with the pressure sensor 37 is desirably a plane.

The pressure sensor 37 is disposed between the first member 33 and the second member 34. The pressure sensor 37 includes, as shown in FIG. 3, a pressure sensor 37a located on the through-hole 342 side (i.e., the grasping section 5 side) via the screw 35 when viewed from a direction in which the first member 33 and the second member 34 overlap and a pressure sensor 37b located on the screw hole 331 side (i.e., the motor 4 side) via the screw 35 when viewed from the direction. In this embodiment, as shown in FIG. 4, the pressure sensors 37a and 37b are configured as separate bodies. In the pressure sensors 37a and 37b disposed in this way, for example, a force F in a direction shown in FIG. 2 is applied to the grasping section 5, a compressing force (a load) is applied to the pressure sensor 37a. A resistance value of the pressure sensor 37a decreases to be smaller than the resistance value of the pressure sensor 37b. On the other hand, when a force in the opposite direction of the force F in the direction shown in FIG. 2 is applied to the grasping section 5, a compression force (a load) is applied to the pressure sensor 37b. The resistance value of the pressure sensor 37b decreases to be smaller than the resistance value of the pressure sensor 37a.

Similarly, the pressure sensor 38 is disposed between the second member 34 and the washer 36. The pressure sensor 38 includes pressure sensors 38a and 38b. However, in the pressure sensors 38a and 38b, when a force is applied to the grasping section 5, the resistance value of the pressure sensor 38b decreases when the resistance value of the pressure sensor 37a decreases and, on the other hand, the resistance value of the pressure sensor 38a decreases when the resistance value of the pressure sensor 37b decreases.

The pressure sensors 37 and 38 are respectively sensors that output signals corresponding to pressures applied to the pressure sensors 37 and 38. The pressure sensors 37 and 38 are respectively pressure sensors of a resistance type. The pressure sensor 37 is more specifically explained below with reference to FIG. 5. The pressure sensor 38 can be configured the same as the pressure sensor 37.

The pressure sensor 37 includes, as shown in FIG. 5, a sheet-like pressure sensitive member 371, a pair of electrodes 372 and 373 disposed on both surfaces of the pressure sensitive member 371, a supporting board 374 supporting the electrode 372, and a supporting board 375 supporting the electrode 373. In the pressure sensor 37, when a pressing force (a contact force) in the thickness direction of the pressure sensor 37 is applied to the pressure sensor 37 by contact with an object around the pressure sensor 37, a resistance value of the pressure sensitive member 371 between the electrodes 372 and 373 changes according to the pressing force. Therefore, the pressing force applied to the pressure sensor 37 can be detected on the basis of the resistance value change.

The pressure sensitive member 371 is formed of a material (pressure sensitive conductive resin) including resin 371a and a conductive material 371b. The resin 371a and the conductive material 371b are desirably mixed. Consequently, the pressure sensitive member 371 can be easily molded in a sheet shape as shown in FIG. 5 (in other words, even if the pressure sensitive member 371 is molded in the sheet shape, the function of the pressure sensor 37 can be exerted). A reduction in the thickness and a reduction in the weight of the pressure sensor 37 can be achieved. Such a pressure sensitive member 371 can be manufactured by, for example, injection molding or roll forming. The thickness of the pressure sensor 37 is not particularly limited. However, for example, the thickness of the pressure sensor 37 is desirably 0.1 mm or more and 1 mm or less and more desirably 0.1 mm or more and 0.5 mm or less. Consequently, it is possible to realize the pressure sensor 37 having sufficiently small thickness while having sufficient mechanical strength.

The resin 371a included in the pressure sensitive member 371 is not particularly limited as long as a necessary function of the pressure sensitive member 371 can be exerted. However, the resin 371a is desirably thermoplastic resin. Consequently, the resin 371a and the conductive material 371b are easily kneaded and have high dispersibility. It is easy to manufacture the pressure sensitive member 371. The thermoplastic resin is not particularly limited. Examples of the thermoplastic resin include polyethylene, polypropylene, polyolefin such as an ethylene-vinyl acetate copolymer, modified polyolefin, polyester (PET, PBT, etc.), polyamide, thermoplastic polyimide, liquid crystal polymer such as aromatic polyester, polyphenylene oxide, polyphenylene sulfide, polycarbonate (PC), polyester carbonate (PPC), polymethyl methacrylate, polyether, polyether ether ketone (PEEK), polyether imide, polyacetal, polyvinyl chloride, and copolymers, blends, polymer alloys, and the like mainly containing these resins. One kind of these resins can be used or one or two kinds of these resins can be mixed and used.

Among these resins, the resin 371a desirably includes at least one resin of polycarbonate (PC) and polyester carbonate (PPC), more desirably includes the resin by 50 weight % or more of the entire resin 371a, and still more desirably includes the resin by 75% or more. Consequently, the effect explained above (kneading easiness) becomes more conspicuous. Since a relatively hard pressure sensitive member 371 is obtained, an allowable load per unit area increases. The mechanical strength of the pressure sensor 37 can be increased. Aged deformation and setting of the pressure sensitive member 371 are prevented. A decrease (fluctuation) in a detection characteristic over time can also be prevented.

A Young's modulus of the resin 371a is desirably GPa or more. Consequently, since a relatively hard pressure sensitive member 371 is obtained, the mechanical strength of the pressure sensor 37 can be increased. Aged deformation and setting of the pressure sensitive member 371 are prevented. A decrease (fluctuation) in a detection characteristic over time can also be prevented.

A load deflecting temperature of the resin 371a is desirably 100° C. or more. Consequently, a decrease in the elasticity of the pressure sensitive member 371 under a high-temperature environment can be prevented. Even under a high-temperature environment, the pressure sensor 37 can exert the same detection accuracy as detection accuracy under a normal temperature environment or a low-temperature environment. That is, the pressure sensitive member 371 is less easily affected by temperature. Fluctuation (drift) of a detection signal due to a temperature change can be reduced. The load deflecting temperature refers to temperature at which the magnitude of deflection reaches a fixed value when the temperature of a sample is raised in a state in which a predetermined load is applied. This means that, as the temperature is higher, heat resistance is higher. The load deflecting temperature can be measured by a test method conforming to JIS 7191.

The conductive material 371b included in the pressure sensitive member 371 is not particularly limited as long as a necessary function of the pressure sensitive member 371 can be exerted. However, a carbon nanotude (CNT) is desirably used. Consequently, the pressure sensitive member 371 is less easily affected by temperature. Fluctuation (drift) of a detection signal due to a temperature change can be reduced. Therefore, for example, excessive temperature correction is unnecessary. A grasping force can be accurately detected. By using the carbon nanotube as the conductive material 371b, a resistance value between the electrodes 372 and 373 smoothly changes with respect to a change in a force (a load) applied to the pressure sensor 37. Further, a resistance value change amount between the electrodes 372 and 373 with respect to the force (the load) applied to the pressure sensor 37 increases. Therefore, a pressing force applied to the pressure sensor 37 can be more accurately detected. As the conductive material 371b, other carbon materials such as carbon black, metal materials, and the like may be used.

A form of the conductive material 371b is not particularly limited. Examples of the form of the conductive material 371b include a particle form and a fiber form. However, the form of the conductive material 371b is desirably the particle form. Consequently, the effect of kneading easiness explained above can be obtained. When the conductive material 371b is the carbon nanotube, for example, the diameter of the carbon nanotube can be set to 100 nm or more and 200 nm or less and the length of the carbon nanotube can be set to 1 μm or more and 5 μm or less. Consequently, the effect can be more effectively exerted.

The content of the conductive material 371b in the pressure sensitive member 371 is not particularly limited. However, for example, the content of the conductive material 371b is desirably 5 wt % or more and 30 wt % or less, more desirably 10 wt % or more and 30 wt % or less, and still more desirably 20 wt % or more and 25 wt % or less. Consequently, reasonable conductivity can be imparted to the pressure sensitive member 371. A decrease in the mechanical strength of the pressure sensitive member 371 due to excessive mixing of the conductive material 371b can be prevented.

The thickness of the pressure sensitive member 371 is not particularly limited. However, for example, the thickness of the pressure sensitive member 371 is desirably 0.01 mm or more and 1 mm or less and more desirably 0.05 mm or more and 0.2 mm or less. Consequently, the pressure sensitive member 371 can sufficiently exert the function of the pressure sensitive member 371. The pressure sensitive member 371 having sufficiently small thickness is obtained. Therefore, it is possible to achieve a reduction in the size of the pressure sensor 37 while maintaining a detection characteristic of the pressure sensor 37.

The pair of electrodes 372 and 373 disposed on both the surfaces of the pressure sensitive member 371 explained above is respectively uniformly disposed over substantially the entire region in the surface direction of the pressure sensitive member 371. A formation range, the shape, and the like of the electrodes 372 and 373 are not particularly limited. The electrodes 372 and 373 may be patterned in, for example, a comb teeth shape. Both of the electrodes 372 and 373 may be disposed on one surface of the pressure sensitive member 371. In this case, for example, the electrodes 372 and 373 only have to be formed in a comb teeth shape to mesh with each other while separating from each other. The electrodes 372 and 373 may be configured such that an intensity distribution in the surface direction of a pressing force in the pressure sensor 37a or the pressure sensor 37b can be detected.

A constituent material of the electrodes 372 and 373 is not particularly limited. Examples of the constituent material include various kinds of metal such as nickel, cobalt, gold, platinum, silver, copper, manganese, aluminum, magnesium, titanium, and tungsten and alloys containing at least one kind of metal among these kinds of metals. One kind of these kinds of metal can be used or two or more kinds of these kinds of metal can be used in combination (e.g., as a stacked structure).

The pair of supporting boards 374 and 375 that supports the pair of electrodes 372 and 373 explained above is not respectively particularly limited. For example, various printed boards such as a flexible board and a rigid board can be used. By using the printed board as the supporting boards 374 and 375 in this way, formation of the electrodes 372 and 373 on the supporting boards 374 and 375 is facilitated. By using the flexible board as at least one of the supporting boards 374 and 375, a reduction in the thickness of the pressure sensor 37 can be easily achieved. On the other hand, by using the rigid board as at least one of the supporting boards 374 and 375, a pressing force is easily applied to the pressure sensitive member 371. The pressing force can be more accurately detected.

As shown in FIG. 4, at least one of the supporting boards 374 and 375 (in FIG. 4, the supporting board 374) includes a portion that supports wires 376 drawn out from the electrodes 372 and 373. In this embodiment, the supporting boards 374 and 375 of the pressure sensor 37a and the supporting boards 374 and 375 of the pressure sensor 37b are configured as separate bodies.

As explained above, the grasping hand 1 includes the grasping section 5, the motor 4 configured to generate a driving force for moving the grasping section 5, and the transmitting mechanism 3 including the first member 33 and the second member 34 configured to transmit the driving force generated by the motor 4 to the grasping section 5. The pressure sensor 37 is provided between the first member and the second member 34. The first member 33 is supported by the feed screw 31 (a shaft member). The first member 33 moves along the feed screw 31 to move the second member 34. The second member 34 moves in a direction parallel to the feed screw 31 to move the grasping section 5.

With such a grasping hand 1, the pressure sensor 37 is provided between the first member 33 and the second member 34 that transmit the driving force generated by the motor 4 to the grasping section 5. Therefore, a force (a grasping force, a pressing force, etc.) applied to the grasping section 5 can be directly detected by the pressure sensor 37. Since the rigidity of the pressure sensor 37 is high, the force applied to the grasping section 5 can be highly accurately detected by the pressure sensor 37. Since the pressure sensor 37 is thin, a reduction in the size and a reduction in the weight of the transmitting mechanism 3 and a reduction in the size and a reduction in the weight of the grasping hand 1 can be achieved.

In this embodiment, the transmitting mechanism 3 includes the washer 36 configured to transmit the driving force generated by the motor 4 to the pair of grasping sections 5. The pressure sensor 38 is disposed between the second member 34 and the washer 36. One of the second member 34 and the washer 36 only has to be grasped as the “first member” according to the invention. The other only has to be grasped as the “second member” according to the invention. The pressure sensor 38 can achieve the same effect as the effect by the pressure sensor 37. By providing both of the pressure sensors 37 and 38, improvement of detection accuracy or detection sensitivity can also be achieved. One of the pressure sensors 37 and 38 may be omitted. In this case, the washer 36 may be omitted.

The transmitting mechanism 3 converts rotation of the motor 4 into an opening and closing motion of the pair of grasping sections 5. Consequently, the pair of grasping sections 5 can be opened and closed by a relatively simple and inexpensive configuration. The mechanism that performs such conversion less easily transmits a force applied to the grasping section 5 to the motor 4. Therefore, displacement of the grasping section 5 by the force can be reduced. The transmitting mechanism 3 only has to be capable of transmitting the driving force generated by the motor 4 to the first member 33 and the second member 34 and opening and closing the pair of grasping sections 5. The transmitting mechanism 3 is not limited to the configuration for performing the conversion explained above. For example, a linear motor may be used as the motor 4. The transmitting mechanism 3 may transmit the driving force generated by the motor 4 to the first member 33 and the second member 34 and open and close the pair of grasping sections 5.

The grasping hand 1 includes the case 2 and the guide 39, which is a guide member supported by the case 2 and configured to guide the second member 34. Consequently, the second member 34 can be stably moved in a desired direction.

The first member 33 and the second member 34 are coupled by the screw 35. Consequently, it is possible to change an output of the pressure sensor 37 according to a force applied to the grasping section 5 while coupling the first member 33 and the second member 34 with relatively high rigidity. The screw 35 couples not only the first member 33 and the second member 34 but also the washer 36. Consequently, it is possible to change an output of the pressure sensor 38 according to the force applied to the grasping section 5 while coupling the second member 34 and the washer 36 with relatively high rigidity.

The pressure sensor 37 includes the pressure sensor 37a, which is a first pressure sensor, disposed on the grasping section 5 side with respect to the screw 35 and the pressure sensor 37b, which is a second pressure sensor, disposed on the opposite side of the grasping section 5 with respect to the screw 35. Consequently, a force applied to the grasping section 5 when the pair of grasping sections 5 approaches can be detected by one sensor out of the pressure sensor 37a and the pressure sensor 37b. A force applied to the grasping section when the pair of grasping sections 5 separates can be detected by the other sensor. The same applies to the pressure sensor 38. The number of pressure sensors included in the pressure sensor 37 or the pressure sensor 38 is not limited to two and may be one or may be three or more.

The pressure sensor 37 is desirably a pressure sensor of the resistance type including the resin 371a and the conductive material 371b. Consequently, a reduction in the thickness and an increase in the rigidity of the pressure sensor 37 can be achieved.

When the pressure sensor 37 is the pressure sensor of the resistance type including the resin 371a and the conductive material 371b in this way, the conductive material 371b is desirably a carbon nanotube. Consequently, the durability, the load resistance, and the rigidity of the pressure sensor 37 can be improved. The same applies to the pressure sensor 38. The pressure sensors 37 and 38 are respectively not limited to the configuration shown in FIG. 5 and may have, for example, a configuration in which pressure sensitive conductive rubber or a piezoresistive element is used.

### Modification

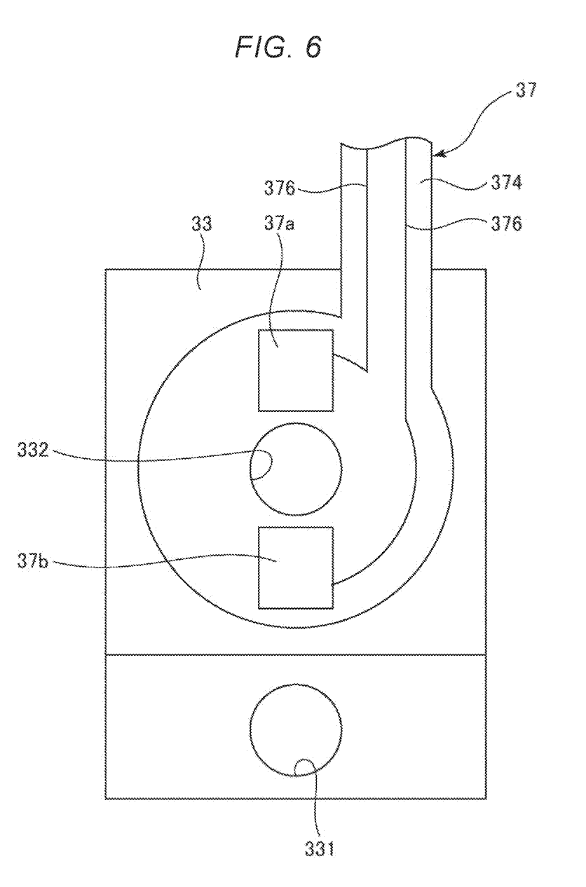

FIG. 6 is a plan view showing a modification of the pressure sensor.

In the embodiment explained above, the example is explained in which the supporting boards 374 and 375 of the pressure sensor 37a and the supporting boards 374 and 375 of the pressure sensor 37b are configured as the separate bodies. However, the supporting boards 374 and 375 may be used in common in the pressure sensors 37a and 37b as shown in FIG. 6. In FIG. 6, at least one of the supporting boards 374 and 375 (in FIG. 6, the supporting board 374) is used in common in the pressure sensors 37a and 37b and includes a portion that supports the wires 376 of the sensors.

In this way, the pressure sensor 37a (the first pressure sensor) and the pressure sensor 37b (the second pressure sensor) are disposed on the supporting board 374, which is the same board. Consequently, laying of the wire 376 of the pressure sensor 37 can be simplified. Alignment of the pressure sensors 37a and 37b can also be simplified.

### Second Embodiment

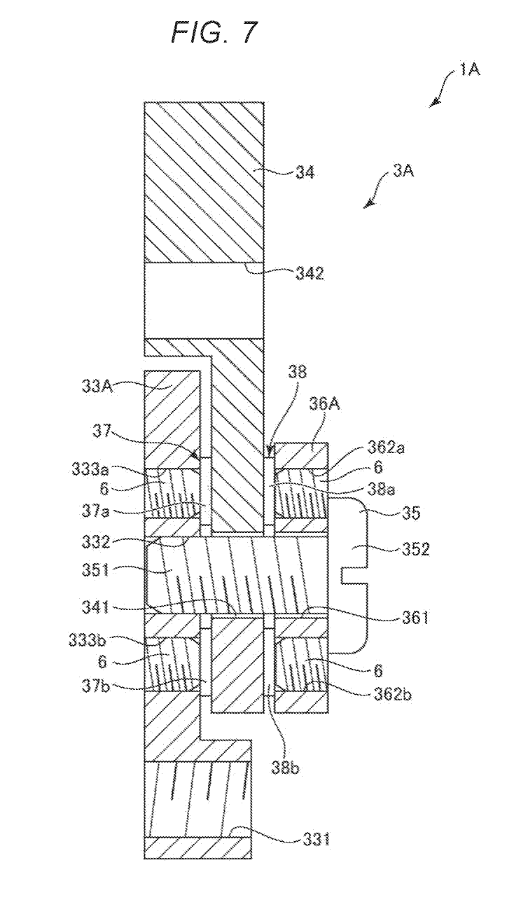

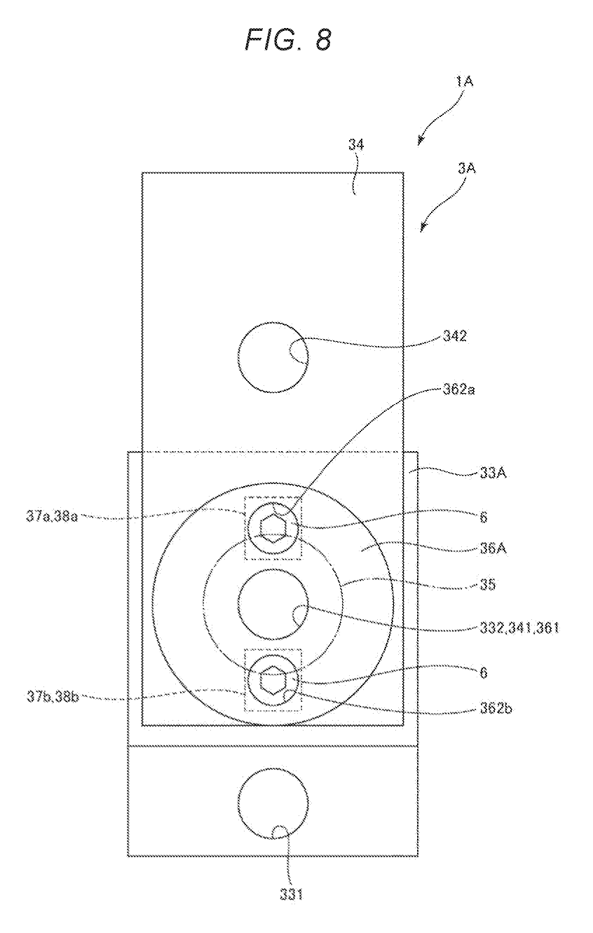

FIG. 7 is an enlarged sectional view showing a first member, a second member, and a pressure sensor included in a grasping hand according to a second embodiment of the invention. FIG. 8 is a plan view of the first member and the second member shown in FIG. 7 viewed from an overlapping direction of the first member and the second member.

In the following explanation, the second embodiment is explained centering on differences from the first embodiment. Explanation of similarities to the first embodiment is omitted. In FIGS. 7 and 8, the same components as the components in the first embodiment are denoted by the same reference numerals and signs.

A transmitting mechanism 3A included in a grasping hand 1A in this embodiment includes a first member 33A and a washer 36A as shown in FIGS. 7 and 8 instead of the first member 33 and the washer 36 of the transmitting mechanism 3 in the first embodiment explained above.

The first member 33A includes a pair of screw holes 333a and 333b in which a screw 6 is screwed. The screw holes 333a and 333b are disposed in positions overlapping the pressure sensors 37a and 37b. The screw 6 screwed in the screw holes 333a and 333b is tightened to the pressure sensors 37a and 37b side to be capable of applying a preload to the pressure sensors 37a and 37b. Consequently, outputs of the pressure sensors 37a and 37b can be adjusted.

Similarly, the washer 36 includes a pair of screw holes 362a and 362b in which the screw 6 is screwed. The screw holes 362a and 362b are disposed in positions overlapping the pressure sensors 38a and 38b. The screw 6 screwed in the screw holes 362a and 362b is tightened to the pressure sensors 38a and 38b side to be capable of applying a preload to the pressure sensors 38a and 38b. Consequently, outputs of the pressure sensors 38a and 38b can be adjusted.

The screw 6 is a hexagonal socket head locking screw (slotted set screw). The screw 6 is not limited to the hexagonal socket head locking screw. Various screws such as a slotted head set screw and a cross (plus) recessed slotted set screw can be used. In FIGS. 7 and 8, the number of screws 6 corresponding to each of the pressure sensors 37a, 37b, 38a, and 38b is one. However, the number of screws 6 is not limited to this. Depending on the size and the like of the sensors, a plurality of screws may be used for one sensor.

According to the second embodiment explained above, the same effects as the effects in the first embodiment can be exerted.

### 2. Robot

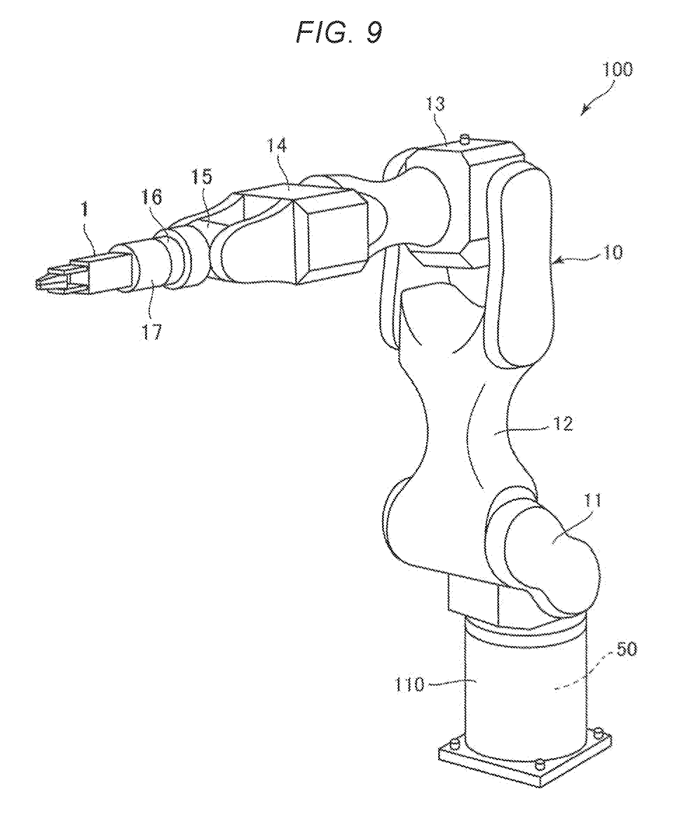

FIG. 9 is a perspective view showing a robot according to an embodiment of the invention. In the following explanation, a base 110 side of a robot 100 is referred to as “proximal end side” and the opposite side of the base 110 side (a grasping hand 1 side) is referred to as “distal end side”.

The robot 100 shown in FIG. 9 is a so-called six-axis vertical articulated robot. The robot 100 can perform work such as supply, removal, conveyance, and assembly of a precision instrument and components configuring the precision instrument (objects). As shown in FIG. 9, the robot 100 includes a base 110, a robot arm 10 turnably coupled to the base 110, a force detecting device 17 attached to the distal end portion of the robot arm 10, the grasping hand 1 mounted on the force detecting device 17, and a control device 50 configured to control driving of the robot arm 10.

The base 110 is fixed on, for example, a floor, a wall, a ceiling, or a movable truck. The robot arm 10 includes an arm 11 (a first arm) turnably coupled to the base 110, an arm 12 (a second arm) turnably coupled to the arm 11, an arm 13 (a third arm) turnably coupled to the arm 12, an arm 14 (a fourth arm) turnably coupled to the arm 13, an arm 15 (a fifth arm) turnably coupled to the arm 14, and an arm 16 (a sixth arm) turnably coupled to the arm 15. The grasping hand 1 (or 1A) is mounted on the distal end face of the arm 16 via the force detecting device 17.

Although not shown in FIG. 9, in joint sections of the robot arm 10, driving sections including motors and speed reducers and angle sensors configured to detect driving states (e.g., rotation angles) of the joint sections are set.

Although not shown in FIG. 9, the control device 50 includes a processor such as a CPU (Central Processing Unit), a memory such as a ROM (Read Only Memory) or a RAM (Random Access Memory), and an I/F (an interface circuit). The processor reads and executes, as appropriate, computer programs stored in the memory, whereby the control device 50 realizes processing such as control of the operation of the robot 100, various arithmetic operations, and determination. The I/F is configured to be communicable with the driving sections, the angle sensors, and the grasping hand 1.

In FIG. 9, the control device 50 is disposed inside the base 110 of the robot 100. However, the control device 50 is not limited to this and may be disposed, for example, on the outside of the base 110. A display device including a monitor such as a display, an input device including, for example, a mouse and a keyboard, and the like may be connected to the control device 50.

As explained above, the robot 100 includes the grasping hand 1 (or 1A). With such a robot 100, characteristics of the robot 100 can be improved using the effects of the grasping hand 1. For example, by achieving a reduction in the size and a reduction in the weight of the grasping hand 1 (or LA), the operation of the robot 100 can be smoothly and highly accurately performed.

The embodiments of the invention are explained above with reference to the drawings. However, the invention is not limited to the embodiments. The components of the sections can be replaced with any components having the same functions. Any other components may be added to the invention.

The invention may be a combination of any two or more configurations (features) in the embodiments explained above.

The robot according to the embodiments is not limited to a single arm robot if the robot includes a robot arm and may be other robots such as a double arm robot and a SCARA robot. The number of arms (the number of joints) included in the robot arm is not limited to the number (six) in the embodiments and may be one or more and five or less or seven or more.

In the embodiments explained above, the example is explained in which the number of grasping sections included in the grasping hand is two (a pair). However, the number of grasping sections is not limited to this and may be three or more or two pairs or more.

The entire disclosure of Japanese Patent Application No. 2017-241646, filed Dec. 18, 2017 is expressly incorporated by reference herein.

What is claimed is:

1. A grasping hand comprising:
a grasping section;
a motor configured to generate a driving force for moving the grasping section; and
a transmitting mechanism including a first member and a second member configured to transmit the driving force to the grasping section, wherein
the first member is supported by a shaft member and moves along the shaft member to move the second member,
the second member moves in a direction parallel to the shaft member to move the grasping section, and
a pressure sensor is provided between the first member and the second member.

2. The grasping hand according to claim 1, wherein the transmitting mechanism converts rotation of the motor into an opening and closing motion of a pair of the grasping sections.

3. The grasping hand according to claim 1, further comprising:
a case; and
a guide member supported by the case and configured to guide the second member.

4. The grasping hand according to claim 1, wherein the first member and the second member are coupled by a screw.

5. The grasping hand according to claim 4, wherein the pressure sensor includes:
a first pressure sensor disposed on the grasping section side with respect to the screw; and
a second pressure sensor disposed on an opposite side of the grasping section with respect to the screw.

6. The grasping hand according to claim 5, wherein the first pressure sensor and the second pressure sensor are disposed on a same board.

7. The grasping hand according to claim 1, wherein the pressure sensor is a pressure sensor of a resistance type including resin and a conductive material.

8. The grasping hand according to claim 7, wherein the conductive material is a carbon nanotube.

9. A robot comprising the grasping hand according to claim 1.

10. A robot comprising the grasping hand according to claim 2.

11. A robot comprising the grasping hand according to claim 3.

12. A robot comprising the grasping hand according to claim 4.

13. A robot comprising the grasping hand according to claim 5.

14. A robot comprising the grasping hand according to claim 6.

15. A robot comprising the grasping hand according to claim 7.

16. A robot comprising the grasping hand according to claim 8.
